(19) United States
(12) Patent Application Publication
(10) Pub. No.: US 2014/0025455 A1
(43) Pub. Date: Jan. 23, 2014

(54) IDENTIFYING SIMILARITY

(71) Applicant: Bernardo Huberman, Palo Alto, CA (US)

(72) Inventor: Bernardo Huberman, Palo Alto, CA (US)

(21) Appl. No.: 14/009,365

(22) PCT Filed: Apr. 6, 2011
(86) PCT No.: PCT/US2011/031340

§ 371 Date: Oct. 2, 2013

(51) Int. Cl. G06F 17/30

(52) U.S. Cl. CPC G06F 17/3053
USPC 705/14.17; 707/723

(57) ABSTRACT

In one implementation, preference information relevant to a set of items that has been submitted on behalf of multiple different users is compared to global ranking information for the set of items that has been compiled based on the preference information submitted on behalf of the multiple different users. Preference information submitted on behalf of a particular user then is identified as being similar to the global ranking information.

### BACKGROUND

Electronic surveys solicit input from users.

### BRIEF DESCRIPTION OF THE DRAWINGS

FIGS. 1A-1F are screenshots of an example of an interface for an electronic survey.

FIG. 2 is a flow chart illustrating an example of a process for identifying user-provided preference information related to a collection of items that is similar to global ranking information for the set of items.

FIG. 3 is a flow chart illustrating an example of a process for conducting an electronic survey.

FIG. 4 is a block diagram of an example of a communications system.

### DETAILED DESCRIPTION

An electronic survey solicits preference information from users for a set of items. The set of items may be some form of media (e.g., songs or other audio tracks, videos, photographs or other graphical elements, books, etc.), textual descriptions (e.g., business ideas, slogans, new product features, etc.), or any other collection of items. In some implementations, the electronic survey may generate a series of pairwise comparisons of items within the set and request that users identify which item within each pair that they prefer. As the users progress through the series of comparisons, the electronic survey gathers preference information from the users for the set of items. The electronic survey then may compile the preference information gathered from the users to construct a global ranking of the items within the set. In some implementations, the electronic survey may not actually gather preference information for each item within the set from each individual user. Nevertheless, the electronic survey still may be able to construct a global ranking of the items within the set based upon the feedback received from all of the users.

In order to incentivize users to participate in the electronic survey and/or to provide meaningful input, the electronic survey may compare the preference information gathered from each individual user to the global ranking of the items and provide a reward to the user who provided the preference information that most closely matches the global ranking of the items. In the case where the preference information provided by two or more users equally matches the global ranking of the items, the electronic survey may split the reward between each of the two or more users.

Furthermore, in some implementations, the electronic survey may charge users a nominal fee to participate in the electronic survey, but then provide the user who provides the preference information that most closely matches the global ranking of the items with a reward that is pooled from the fees collected. For example, the electronic survey may charge users $1 to participate in the survey and then reward the user who provides the preference information that most closely matches the global ranking of the items with some percentage of the fees collected from the participants. In this example, the electronic survey also may retain the balance of the fees collected from the participants not paid out as a reward as its fee for conducting the survey.

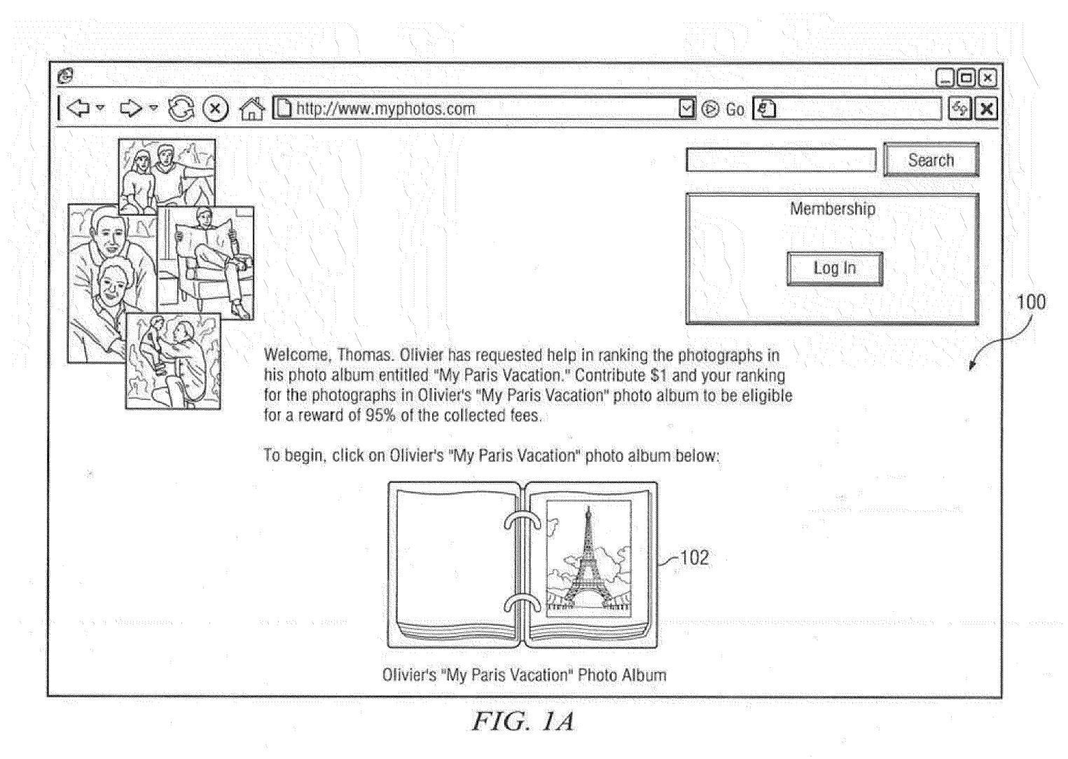

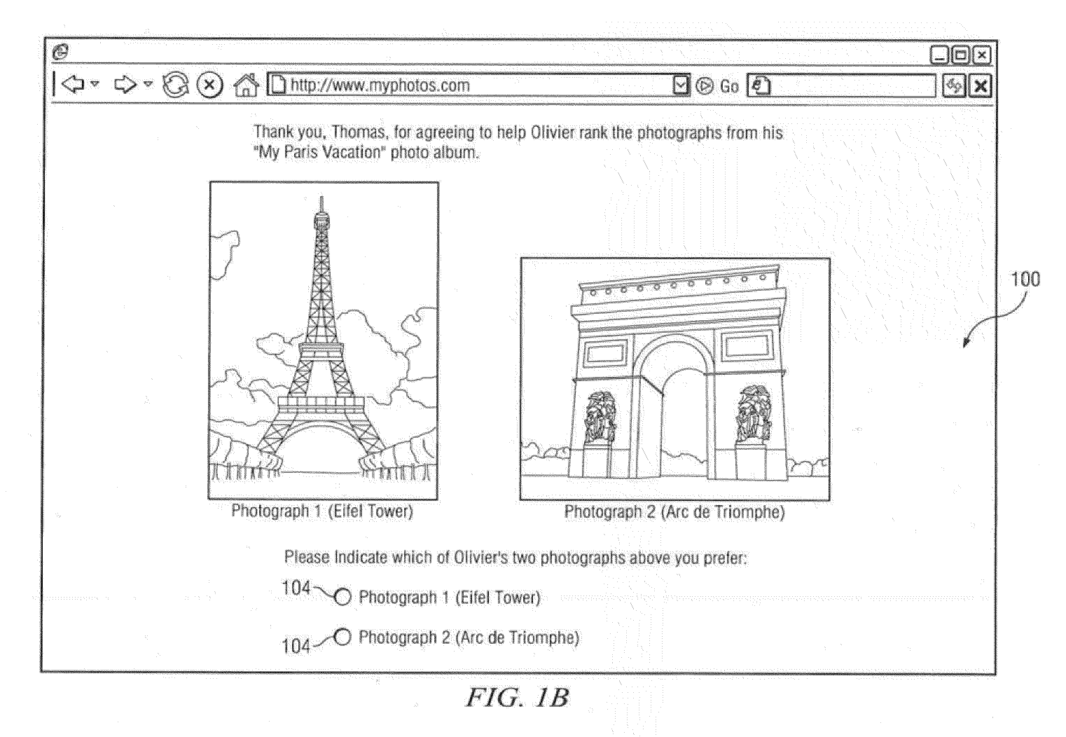

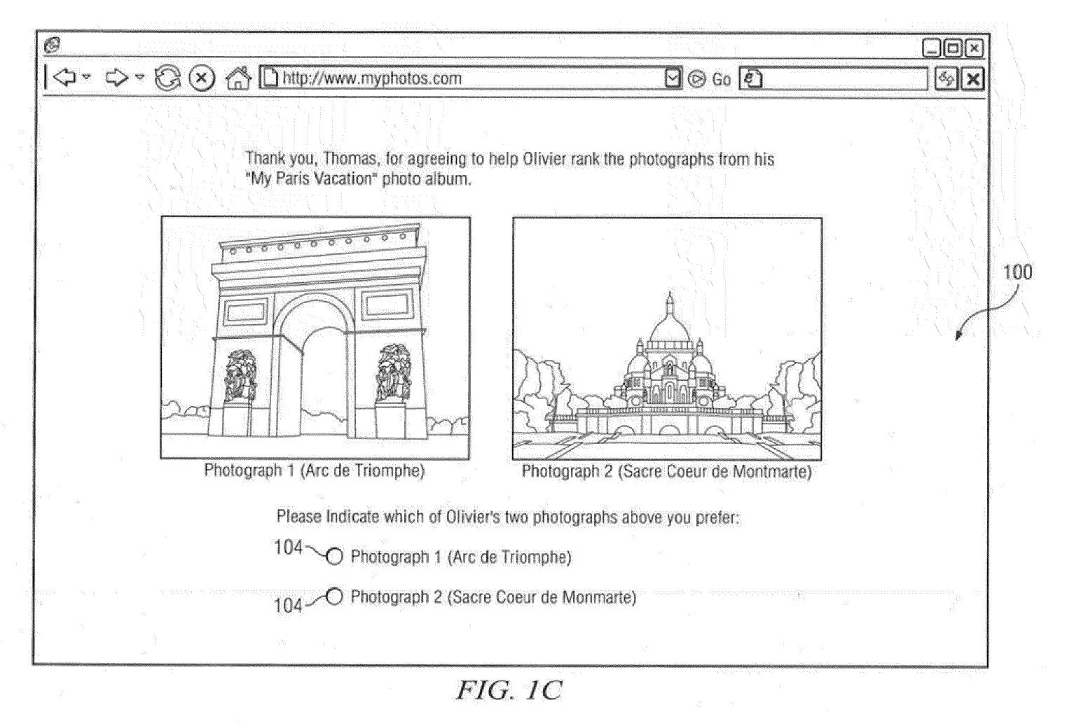

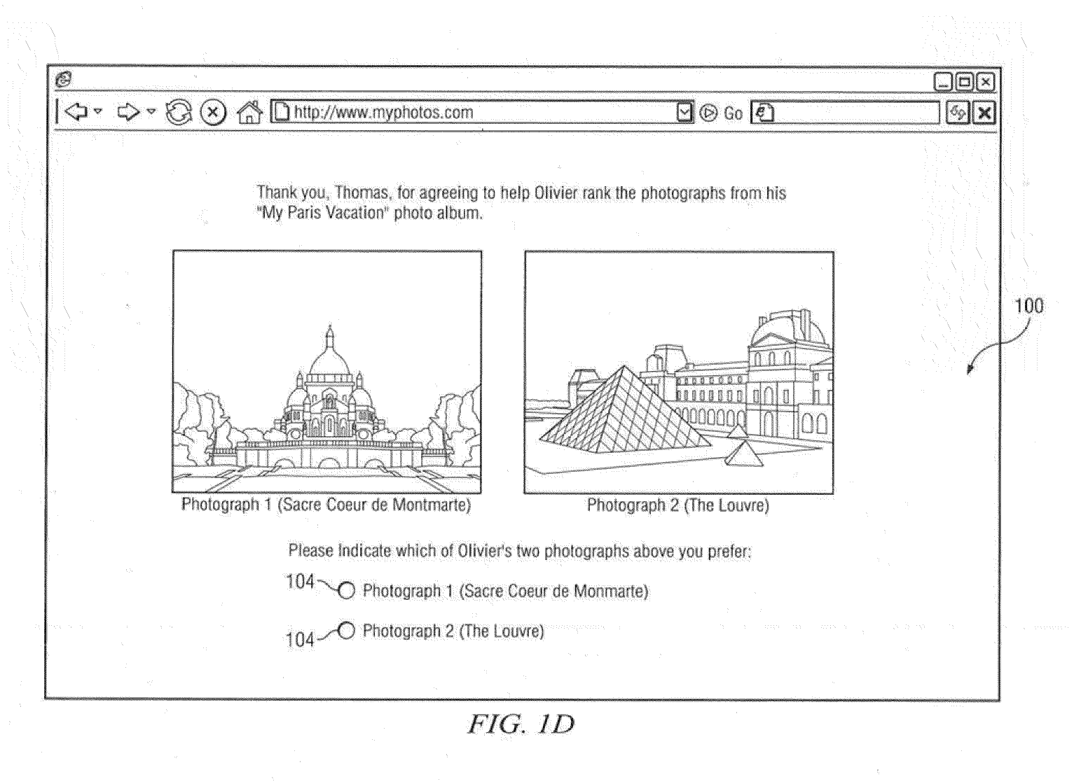

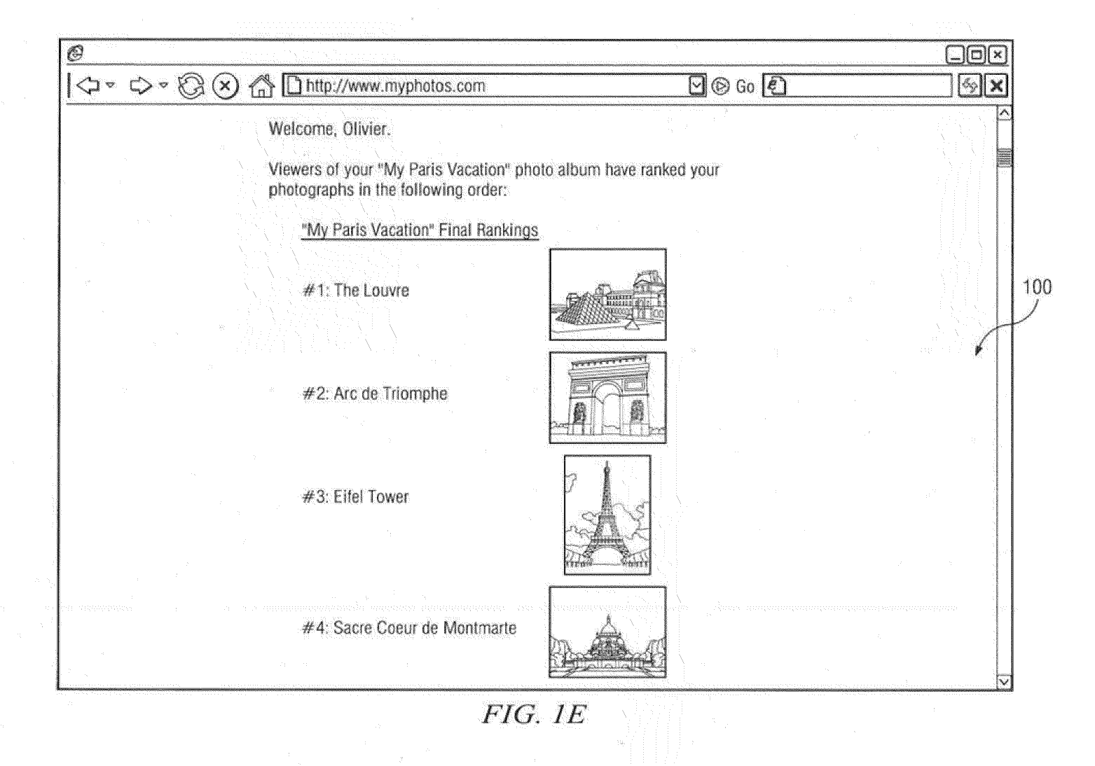

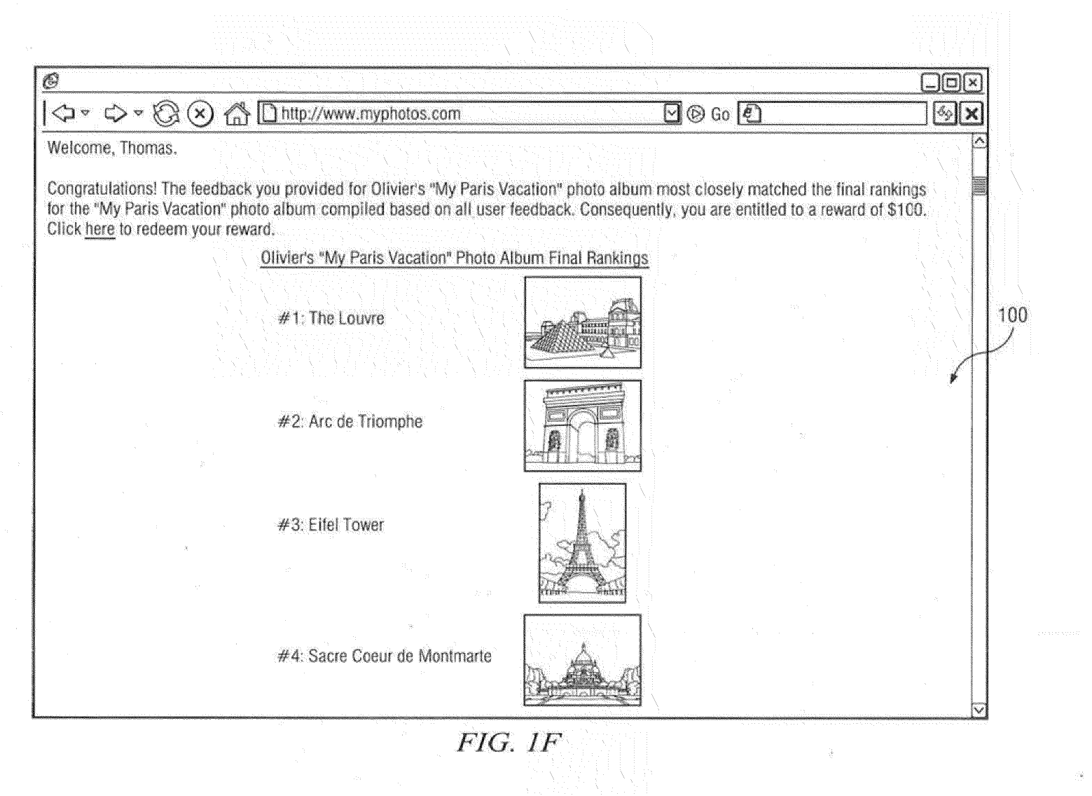

FIGS. 1A-1F are screenshots of an example of an interface 100 for an electronic survey. As illustrated in FIG. 1A, the interface 100 invites a user to participate in an electronic survey to help rank photographs from another user's electronic photo album. As explained by the interface 100, by contributing $1 and participating in the survey, the user will be eligible for a reward of 95% of the fees collected from the users who participate in the survey.

Referring now to FIGS. 1B-1D, after the user agrees to participate in the electronic survey, the interface 100 presents a series of pairs of photographs from the photo album and asks the user to indicate which photograph of each pair the user prefers by selecting a corresponding radio button 104. The electronic survey then may use the pairwise preference information received from the user to calculate a ranking of the photographs exposed to the user. In some implementations, the user may not be asked to evaluate each photograph within the photo album. Instead, the user may be asked to evaluate a subset of less than all of the photographs in the photo album.

The electronic survey also solicits preference information regarding photographs in the photo album from multiple other users. The electronic survey then may us the pairwise preference information received from each of the other users to calculate rankings of photographs for each of the individual users. As mentioned above, the electronic survey may not expose each individual user to all of the photographs in the photo album. Instead, the electronic survey may expose the individual users to subsets of less than all of the photographs in the photo album, and the individual rankings of the photographs for any one user may include rankings only of the photographs within the subset exposed to that user.

The electronic survey compiles the preference information received from the users and generates a global ranking for the photographs in the photo album based on preference information received from the users. As illustrated in FIG. 1E, the interface 100 then may present this global ranking of the photographs in the photo album to the user who created the photo album. This information may be useful to the user who created the photo album, for example, in helping the user to decide which of the photographs in the photo album to have printed, enlarged, or framed.

In addition to constructing a global ranking for the photographs in the photo album based on the preference information received from all of the users, the electronic survey also may compare the global ranking for the photographs in the photo album to the photograph rankings calculated for the individual users to determine which of the photograph rankings calculated for the individual users most closely matches the global ranking compiled based on all of the user preference information. The electronic survey then rewards the user whose personal preference information most closely matches the global ranking with a monetary prize. For example, as illustrated in FIG. 1F, the interface 100 informs the user that the preference information received from the user during the course of participating in the electronic survey most closely matched the final rankings for the photographs in the photo album compiled based on all of the user feedback received and that, therefore, the user is entitled to a monetary reward of $100, or 95% of the total fees collected from the participants in the survey. The electronic survey may retain the remaining 5% of the fees collected from the participants in the survey as its fee for conducting the electronic survey.

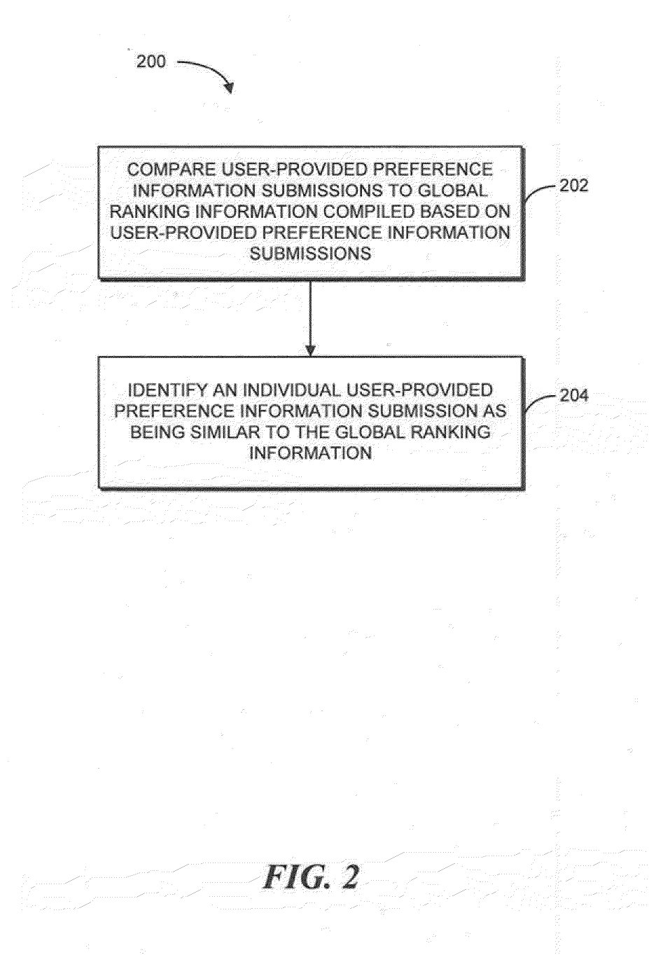

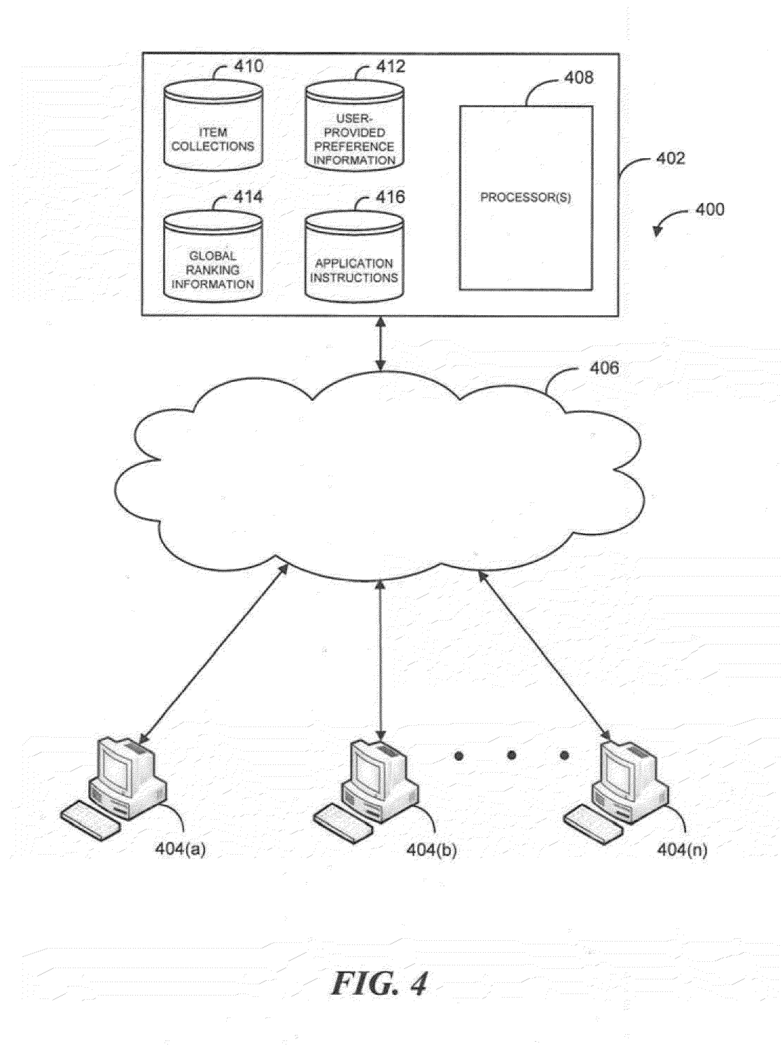

FIG. 2 is a flow chart 200 illustrating an example of a process for identifying user-provided preference information related to a collection of items that is similar to global ranking information for the set of items. The process illustrated in the flowchart 200 of FIG. 2 may be performed by a computing system such as, for example, host computing system 402 illustrated in FIG. 4 and described in greater detail below. More specifically, the process illustrated in the flowchart 200 of FIG. 2 may be performed by one or more of the processor(s) 408 of the host computing system 402 as a consequence of executing the application instructions 416 illustrated in FIG. 4 and described in greater detail below.

As discussed above, an electronic survey implemented by a computing system may gather preference information for a collection of items from a number of different users. In some implementations, the preference information gathered from individual users may address subsets of less than all of the items in the collection. The electronic survey implemented by a computing system then may compile the preference information gathered from the individual users and construct a global ranking for all of the items within the collection based on the preference information gathered from the individual users.

At 202, user-provided preference information submissions related to the collection of items are compared to global ranking information for the collection of items that was compiled based on the user-provided preference information submissions. Let U represent the collection of items and let σ represent the global ranking for the collection of items such that σ is an ordered list of the items within U (i.e., σ=[x₁≧x₂≧ . . . ≧xₙ] where each xᵢεU, |U|=|x|, and | | denotes the number of items in a list. In one example, τ₁ . . . τₖ represents individual rankings of items in the collection U based on user-provided preference information where each τᵢ is an ordered list (either partial or complete) of items in the collection U. In this example, the user-generated rankings τ₁ . . . τₖ may be compared to the global ranking for the collection of items by calculating a distance between each of the individual user-generated rankings τ₁ . . . τₖ and the global ranking a for the collection of items. One approach for calculating this distance involves taking the sum of the absolute difference between the scaled rank for each item in the individual user-generated ranking and the corresponding scaled rank for the same item in the global ranking, where the contributions of the ranks from both the individual user-generated rankings and the global ranking are scaled based on their sizes. This can be expressed formally as:

$$F ( τ , σ ) = {\sum }_{i ∈ τ} \vert \frac{τ ( i )}{\vert τ \vert} - \frac{σ ( i )}{\vert σ \vert} \vert \qquad ( Eq . 1 )$$

This distance then may be normalized by dividing F by |τ|/2. Alternatively, different approaches may be used to calculate the distance between each individual user-generated ranking τ₁ . . . τₖ and the global ranking a for the collection of items. In fact, in some implementations, approaches other than calculating a distance between each of the individual user-generated rankings τ₁ . . . τₖ and the global ranking a for the collection of items may be employed to compare the similarity between each of the individual user-generated rankings τ₁ . . . τₖ and the global ranking σ for the collection of items.

Referring again to FIG. 2, after the user-provided preference information submissions have been compared to the global ranking information for the collection of items, an individual user-provided preference information submission is identified as being similar to the global ranking information at 204. More particularly, an individual user-provided preference information submission from among all of the user-provided feedback submissions may be identified as being most similar to the global ranking information. For example, returning again to the example introduced above where the user-provided preference information submissions are compared to the global ranking for the collection of items by calculating a normalized distance between individual user-generated rankings and the global ranking for the collection of items as described in connection with Equation 1, the individual one of the user-generated rankings with the shortest normalized distance to the global ranking information may be identified as being most similar to the global ranking information. In alternative implementations, an individual user-generated ranking may be identified as being similar to the global ranking information if the normalized distance between the individual user-generated ranking and the global ranking is less than a predetermined threshold distance.

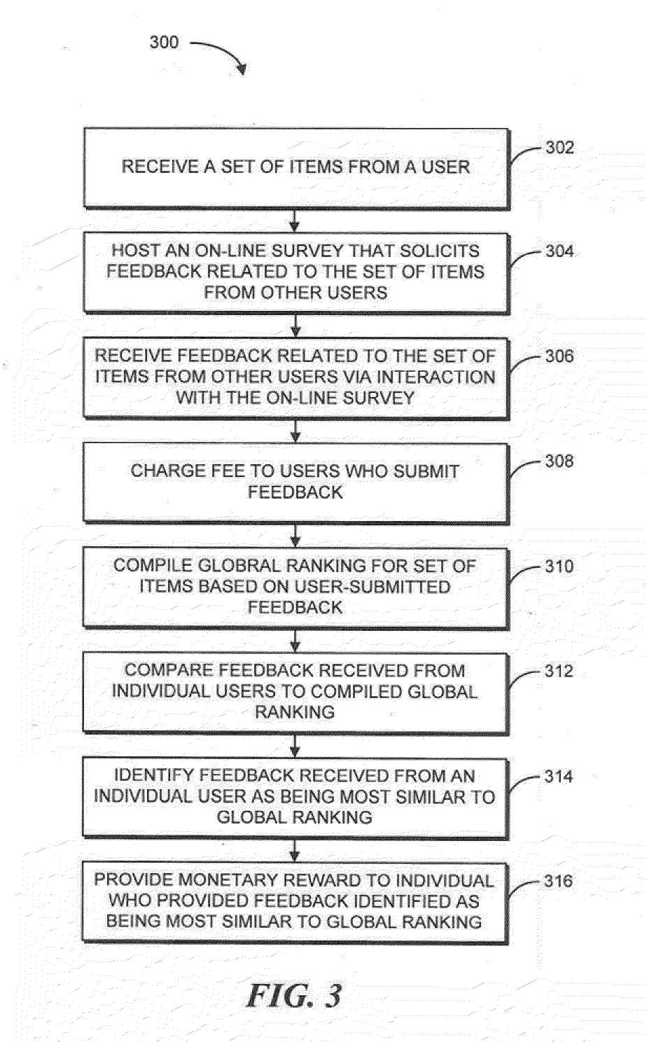

FIG. 3 is a flow chart 300 illustrating an example of a process for conducting an electronic survey. The process illustrated in the flowchart 300 of FIG. 3 may be performed by a computing system such as, for example, host computing system 402 illustrated in FIG. 4 and described in greater detail below. More specifically, the process illustrated in the flowchart 300 of FIG. 3 may be performed by one or more of the processor(s) 408 of the host computing system 402 as a consequence of executing the application instructions 406 illustrated in FIG. 4 and described in greater detail below.

At 302, a set of items is received from a user. As discussed above, the set of items may be some form of media (e.g., songs or other audio tracks, videos, photographs or other graphical elements, books, etc.), textual descriptions (e.g., business ideas, slogans, new product features, etc.), or any other collection of items. Then, at 304, an on-line survey is hosted that solicits feedback related to the set of items from other users. For example, as described above in connection with FIGS. 1A-1F, the on-line survey may be implemented in the form of requesting users to perform a series of pairwise comparisons of items from among the set of items. In some cases, the series of pairwise comparisons that a user is requested to perform may not involve the entire set of items. Instead, the pairwise comparisons that the user is requested to perform may involve a subset of less than all of the items in the set. In alternative implementations, the on-line survey may not be implemented by requesting users to perform series of pairwise comparisons. Instead, the on-line survey may request that users rank the items in the set or that users rank some subset of the items in the set.

At 306, feedback related to the set of items is received from users via interaction with the on-line survey. For example, in implementations in which the on-line survey is implemented by requesting users to perform a series of pairwise comparisons between different items within the set, the feedback received from the users may be in the form of pairwise preferences for certain items over other items. A ranking of the items in the set to which the user was exposed then may be constructed based on the pairwise preferences received from the user. Various different techniques may be employed to construct a ranking for the user based on the pairwise preference information received from the user. For example, in some implementations, the pairwise preference information received from a user may be converted into one or more beatpaths from which a ranking of the items to which the user was exposed may be derived. In alternative implementations, some variation of the Elo rating system (where a score is associated with each item and the score is increased when the item “wins” a pairwise comparison and decreased when the item “loses” a pairwise comparison with the magnitude of the increase or decrease depending on the difference between the score of the item and the score of the item to which it is being compared) may be used to convert the pairwise preference information received from the user into a ranking of the items to which the user was exposed.

In implementations in which the on-line survey is implemented by requesting users to rank the items in the set or some subset of the items in the set, the feedback received from the users already may be in the form of rankings.

At 308, the users who participate in the on-line survey are charged a fee. Various different techniques may be employed to collect such fees. For example, in some implementations, a credit card transaction may be processed in order to collect the fee. The fee also may be collected by executing an electronic funds transfer to transfer funds from a bank or other financial account of the user to a bank or other financial account of a party responsible for operating the on-line survey. Additionally or alternatively, the on-line survey may host financial accounts for users of the on-line survey system and the fee may be charged by debiting the financial account for the appropriate user.

At 310, the individual feedback submissions received from the survey participants are compiled, and a global ranking for the set of items is generated based on the individual feedback submissions received from the survey participants. Here again, a number of different techniques may be employed to generate the global ranking for the set of items from the individual feedback submissions received from the survey participants. For example, if the individual feedback submissions are taken in the form of rankings of the set of items or rankings of subsets of less than all of the items, variations of the Schulze method may be used to generate the global ranking for the set of items. Alternatively, if the individual feedback submissions are taken in the form of pairwise preferences, some variation of the Elo rating system may be used to generate a global ranking for the set of items based on the pairwise preferences received from the survey participants.

At 312, the feedback received from each of the individual survey participants is compared to the global ranking information for the set of items. For instance, the feedback received from each of the individual survey participants may be taken as rankings for the set of items or a subset of less than all of the items and compared to the global ranking information, for example, by calculating normalized distances between the rankings for the individual survey participants and the global ranking information as described above in connection with Equation 1.

Then, at 314, feedback received from an individual survey participant is identified as being most similar to the global ranking information based on having compared the feedback received from each of the individual survey participants to the global ranking information. For example, in implementations in which the feedback received from each of the individual survey participants is compared to the global ranking information by calculating distances between item rankings based on individual participant feedback to the global ranking information, the participant that provided feedback that is most similar to the global ranking information may be identified by determining which of the item rankings based on individual participant feedback is closest to the global ranking information.

After identifying feedback received from an individual survey participant as being most similar to the global ranking information, a monetary reward is provided, at 316, to the individual survey participant who provided the feedback identified as being most similar to the global ranking information. Various different techniques may be employed to provide this monetary reward to the individual survey participant. For example, in some implementations, an electronic funds transfer may be executed to transfer funds from a bank or other financial account of the party responsible for operating the on-line survey to a bank or other financial account of the individual survey participant. Alternatively, the on-line survey may host financial accounts for users of the on-line survey system and the monetary reward may be provided to the individual survey participant by crediting the financial account for the individual survey participant. The monetary reward also may be provided to the individual survey participant by sending a check to the individual survey participant drawn on a bank or other financial account of the party responsible for operating the on-line survey.

In some implementations, the monetary reward provided to the individual survey participant who provided the feedback identified as being most similar to the global ranking may be the total of the fees collected from the other survey participants. Alternatively, the monetary reward may be a fraction of the total of the fees collected from the other survey participants, and the party responsible for operating the on-line survey may retain the balance of the fees collected from the other survey participants as its fee for hosting the on-line survey.

In some implementations, the on-line survey may enforce a policy that a survey participant is not eligible to receive the monetary reward until the survey participant has supplied at least a threshold amount of feedback in connection with the survey. For example, in cases in which the on-line survey is implemented by requesting participants to perform a series of pairwise comparisons of items in a collection, the on-line survey may enforce a policy that a participant may not be eligible to receive a monetary reward unless the participant has completed a threshold number of such pairwise comparisons.

FIG. 4 is a block diagram of an example of a communications system 400 that includes host computing system 402, client computers 404(a)-404(n), and a network 406. For illustrative purposes, several elements illustrated in FIG. 4 and described below are represented as monolithic entities. However, these elements each may include and/or be implemented on numerous interconnected computing devices and other components that are designed to perform a set of specified operations and that are located proximally to one another or that are geographically displaced from one another.

As illustrated in FIG. 4, the host computing system 402 is accessible to client computers 404(a)-404(n) over network 406.

Client computers 404(a)-404(n) may be any of a number of different types of computing devices including, for example, personal computers, special purpose computers, general purpose computers, combinations of special purpose and general purpose computing devices, laptop computers, tablet computers, netbook computers, smart phones, mobile phones, personal digital assistants, and portable media players. Client computers 404 typically have internal or external storage components for storing data and programs such as operating systems and application programs. Among such application programs, the internal or external storage components may store dedicated client applications for interfacing with host computing system 402. Alternatively, in some implementations, client computers 404(a)-404(n) may interface with host computing system 402 without a dedicated client application (e.g., using a web browser application stored in internal or external storage components).

Client computers 404(a)-404(n) also typically include central processing units (CPUs) for executing instructions stored in storage and/or received from one or more other electronic devices, for example, over network 406. In addition, client computers 404(a)-404(n) also usually include one or more communication devices for sending and/or receiving data. One example of such a communications device is a modem. Other examples include an antenna, a transceiver, a communications card, and other types of network adapters capable of transmitting and receiving data over network 406 through a wired or wireless data pathway.

Network 406 may provide direct or indirect communication links between host computer system 402 and client computers 404(a)-404(n) irrespective of the physical separation between any of such devices. As such, host computer system 402 and client computers 404(a)-404(n) may be located in close geographic proximity to one another or, alternatively, host computer system 402 and client computers 404(a)-404(n) may be separated by vast geographic distances. Examples of network 406 include the Internet, the World Wide Web, wide area networks (WANs), local area networks (LANs) including wireless LANs (WLANs), analog or digital wired and wireless telephone networks, radio, television, cable, satellite, and/or any other delivery mechanisms for carrying data.

Host computer system 402 may be implemented using one or more computing devices (e.g., servers) that include network interfaces for sending and receiving data over a network (e.g., network 406) and that are configured to provide services to one or more client devices (e.g., client computers 404(a)-404(n)) connected to host computer system 402 over a network (e.g., network 406). The one or more computing devices on which host computer system 402 is implemented may include one or more processors 408 for executing instructions.

In addition, the one or more computing devices on which host computer system 402 is implemented may have internal or external storage components storing data and programs. The data may include collections of items 410 to be or that have been ranked. In addition, the data also may include user provided ranking preference 412 for some or all of the item collections 410, and global ranking information 414 for some or all of the item collections 410 compiled based on the user provided preference information 412 as discussed above. The programs, meanwhile, may include an operating system as well as application instructions 416 that, when executed by processors 408, cause the one or more computing devices on which host computer system 402 is implemented to provide the on-line survey functionality described herein.

For example, application instructions 416 may enable host computer system 402 to receive and store item collections 410 from users of one or more of client computing devices 404(a)-404(n). In addition, application instructions 416 also may enable host computer system 402 to host on-line surveys that solicit user preference information for the items within item collections 410 from users of one or more of client computing devices 404(a)-404(n), to store such user preference information as user provided preference information 412, and to compile global ranking information 414 for the item collections 410 based on the user provided preference information 412. Furthermore, application instructions 416 also may enable host computer system 402 to compare user provided preference information 412 for a particular item collection 410 with corresponding global ranking information 414 for the particular item collection and to identify particular user provided preference information for the particular item collection as being most similar to the global ranking information 414 for the particular item collection 410. The application instructions 416 also may enable the host computer system 402 to provide a reward to the user who provided the preference information 412 determined to be most similar to the global ranking information 414.

As described above, in one general aspect, preference information submissions relevant to a set of items submitted on behalf of multiple different users is compared to global ranking information for the set of items compiled based on the preference information submissions submitted on behalf of the multiple different users, and an individual one of the preference information submissions submitted on behalf of a particular user is identified as being similar to the global ranking information.

Implementations may include one or more of the following features. For example, identifying the individual preference information submission submitted on behalf of the particular user as being similar to the global ranking information may include identifying the individual preference information submission submitted on behalf of the particular user as being most similar, among the preference information submissions, to the global ranking information. Additionally or alternatively, the individual preference information submission submitted on behalf of the particular user may be identified as being similar to the global ranking information based on results of comparing the preference information submissions submitted on behalf of the different users to the global ranking information.

In some implementations, a reward may be provided to the particular user as a consequence of having identified the individual preference information submission as being similar to the global ranking information. For example, a monetary reward may be provided to the particular user, in some cases by crediting a financial account maintained on behalf of the user with a monetary sum. Furthermore, the preference information submissions submitted on behalf of the different users may be received. In addition, a monetary fee may be received in connection with each preference information submission and the monetary reward provided to the particular user may be greater than the monetary fee.

In some implementations, at least some of the preference information submissions submitted on behalf of users, including the individual preference submission submitted on behalf of the particular user, may include preference information for less than the entire set of items. In such implementations, comparing preference information submissions relevant to a set of items submitted on behalf of multiple different users to global ranking information for the set of items compiled based on the preference information submissions submitted on behalf of the multiple different users may include comparing the global preference information for the set of items to ranking information submissions that include preference information for less than the entire set of items. In addition, identifying the individual preference information submission submitted on behalf of the particular user as being similar to the global ranking information may include identifying the individual preference information submission that includes preference information for less than the entire set of items as being similar to the global ranking information.

The global ranking information for the set of items may include a rank-ordered list of the set of items. In such implementations, comparing preference information submissions relevant to the set of items submitted on behalf of the different users to the global ranking information for the set of items may include comparing the preference information submissions relevant to the set of items to the rank-ordered list of the set of items.

The set of items may be a set of photographs or a set of textual descriptions. As such, preference information submissions submitted on behalf of multiple different users relevant to a set of photographs or a set of textual descriptions may be compared to a global set of ranking information for the set of photographs or textual descriptions.

In another general aspect, indications of feedback related to at least some of a set of items provided by multiple different users are accessed. Global ranking information for the set of items compiled based on the received indications of feedback provided by the different users also is accessed, and the global ranking information for the set of items is compared to the indications of feedback provided by each of the different users. Based on comparing the global ranking information to the indications of feedback provided by each of the different users, feedback provided by a particular one of the users is identified as being most similar to the global ranking information, and the particular user is provided with a monetary reward as a consequence of having identified the feedback provided by the particular user as being most similar to the global ranking information.

In some implementations, each of the users who provide feedback related to the set of items may be charged a monetary fee, and the particular user may be provided with a monetary reward that is greater than the monetary fee.

In yet another general aspect, a set of items is received on behalf of a user and an on-line survey is hosted that solicits feedback related to the set of items from other users. Indications of feedback related to at least some of the items provided by multiple different users via interaction with the on-line survey is received. Global ranking information for the set of items compiled based on the received indications of feedback provided by the different users is accessed and compared to the indications of feedback provided by each of the different users. Based on comparing the global ranking information to the indications of feedback provided by each of the different users, feedback provided by a particular one of the users is identified as being most similar to the global ranking information. The particular user then is provided with a monetary reward as a consequence of having identified the feedback provided by the particular user as being most similar to the global ranking information.

In some implementations, each of the users for whom indications of feedback related to the set of items was received may be charged a monetary fee, and the particular user may be provided with a monetary reward that is greater than the monetary fee.

A number of implementations have been described. However, other variations also are within the scope of this disclosure. For example, although electronic surveys generally are described above in the context of a hosted electronic survey made available to remote client devices, in some implementations, an electronic survey may be implemented at a user device and input to the electronic survey may be received directly at the user device. Furthermore, although global ranking information is described above generally in the context of an ordered list of items in a collection, such global ranking information may not necessarily take the form of an ordered list of every item in the collection. Rather, more generally, global ranking information may simply convey overall user preferences for some items in the collection relative to other items in the collection. Additionally or alternatively, in some implementations, individual user preference information for a collection may be identified as being most similar to global ranking information for the collection based on a determination that the individual user preference information identifies the same item within the collection as being the favorite as the global preference information.

A number of methods, techniques, systems, and apparatuses have been described. The described methods, techniques, systems, and apparatuses may be implemented in digital electronic circuitry or computer hardware, for example, by executing instructions stored in computer-readable storage media.

Apparatuses implementing these techniques may include appropriate input and output devices, a computer processor, and/or a tangible computer-readable storage medium storing instructions for execution by a processor.

A process implementing techniques disclosed herein may be performed by a processor executing instructions stored on a tangible computer-readable storage medium for performing desired functions by operating on input data and generating appropriate output. Suitable processors include, by way of example, both general and special purpose microprocessors. Suitable computer-readable storage devices for storing executable instructions include all forms of non-volatile memory, including, by way of example, semiconductor memory devices, such as Erasable Programmable Read-Only Memory (EPROM), Electrically Erasable Programmable Read-Only Memory (EEPROM), and flash memory devices; magnetic disks such as fixed, floppy, and removable disks; other magnetic media including tape; and optical media such as Compact Discs (CDs) or Digital Video Disks (DVDs). Any of the foregoing may be supplemented by, or incorporated in, specially designed application-specific integrated circuits (ASICs).

Although the operations of the disclosed techniques may be described herein as being performed in a certain order and/or in certain combinations, Individual operations may be rearranged in a different order, performed in combination with other operations described herein, and/or eliminated and the desired results still may be achieved. Similarly, components in the disclosed systems may be combined in a different manner and/or replaced or supplemented by other components and the desired results still may be achieved.

What is claimed is:

1. A computer-implemented method comprising:
comparing preference information submissions relevant to a set of items submitted on behalf of multiple different users to global ranking information for the set of items compiled based on the preference information submissions submitted on behalf of the multiple different users; and
identifying an individual one of the preference information submissions submitted on behalf of a particular user as being similar to the global ranking information.

2. The method of claim 1 wherein identifying the individual preference information submission submitted on behalf of the particular user as being similar to the global ranking information includes identifying the individual preference information submission submitted on behalf of the particular user as being most similar, among the preference information submissions, to the global ranking information.

3. The method of claim 1 wherein identifying the individual preference information submission submitted on behalf of the particular user as being similar to the global ranking information includes identifying the individual preference information submission submitted on behalf of the particular user as being similar to the global ranking information based on results of comparing the preference information submissions submitted on behalf of the different users to the global ranking information.

4. The method of claim 1 further comprising providing a reward to the particular user as a consequence of having identified the individual preference information submission as being similar to the global ranking information.

5. The method of claim 4 wherein providing a reward to the particular user includes providing a monetary reward to the particular user.

6. The method of claim 5 wherein providing a monetary reward to the particular user includes crediting a financial account maintained on behalf of the user with a monetary sum.

7. The method of claim 5 further comprising:
receiving the preference information submissions submitted on behalf of the different users; and
receiving, in connection with each preference information submission, a monetary fee, wherein:
providing a monetary reward to the particular user includes providing a monetary reward to the user that is greater than the monetary fee.

8. The method of claim 1 wherein at least some of the preference information submissions submitted on behalf of users, including the individual preference submission submitted on behalf of the particular user, include preference information for less than the entire set of items, such that:
comparing preference information submissions relevant to a set of items submitted on behalf of multiple different users to global ranking information for the set of items compiled based on the preference information submissions submitted on behalf of the multiple different users includes comparing the global preference information for the set of items to ranking information submissions that include preference information for less than the entire set of items; and
identifying the individual preference information submission submitted on behalf of the particular user as being similar to the global ranking information includes identifying the individual preference information submission that includes preference information for less than the entire set of items as being similar to the global ranking information.

9. The method of claim 1 wherein the global ranking information for the set of items includes a rank-ordered list of the set of items such that comparing preference information submissions relevant to the set of items submitted on behalf of the different users to the global ranking information for the set of items includes comparing the preference information submissions relevant to the set of items to the rank-ordered list of the set of items.

10. The method of claim 1 wherein the set of items is a set of photographs such that comparing preference information submissions relevant to a set of items submitted on behalf of multiple different users to global ranking information for the set of items includes comparing preference information submissions submitted on behalf of multiple different users relevant to a set of photographs to a global set of ranking information for the set of photographs.

11. The method of claim 1 wherein the set of items is a set of textual descriptions such that comparing preference information submissions relevant to a set of items submitted on behalf of multiple different users to global ranking information for the set of items includes comparing preference information submissions submitted on behalf of multiple different users relevant to a set of textual descriptions to a global set of ranking information for the set of textual descriptions.

12. A non-transitory computer-readable storage medium storing instructions that, when executed, cause a computer to:
access indications of feedback related to at least some of a set of items provided by multiple different users;
access global ranking information for the set of items compiled based on the received indications of feedback provided by the different users;
compare the global ranking information for the set of items to the indications of feedback provided by each of the different users;
based on comparing the global ranking information to the indications of feedback provided by each of the different users, identify feedback provided by a particular one of the users as being most similar to the global ranking information; and
provide the particular user with a monetary reward as a consequence of having identified the feedback provided by the particular user as being most similar to the global ranking information.

13. The computer-readable storage medium of claim 12 further comprising instructions that, when executed, cause the computer to charge each of the users who provide feedback related to the set of items a monetary fee, wherein the instructions that, when executed, cause the computer to provide the particular user with a monetary reward include instructions that, when executed, cause the computer to provide the particular user with a monetary reward that is greater than the monetary fee.

14. A system comprising:
one or more processing elements; and
computer memory storing instructions that, when executed by the one or more processing elements, cause the processing elements to:
receive a set of items on behalf of a user;
host an on-line survey that solicits feedback related to the set of items from other users;
receive indications of feedback related to at least some of the items provided by multiple different users via interaction with the on-line survey;
access global ranking information for the set of items compiled based on the received indications of feedback provided by the different users;
compare the global ranking information for the set of items to the indications of feedback provided by each of the different users;
based on comparing the global ranking information to the indications of feedback provided by each of the different users, identify feedback provided by a particular one of the users as being most similar to the global ranking information; and
provide the particular user with a monetary reward as a consequence of having identified the feedback provided by the particular user as being most similar to the global ranking information.

15. The system of claim 14 wherein:
the computer memory further stores instructions that, when executed by the one or more processing elements, cause the processing elements to charge each of the users for whom indications of feedback related to the set of items was received a monetary fee; and
the instructions that, when executed by the processing elements, cause the processing elements to provide the particular user with a monetary reward include instructions that, when executed, cause the computer to provide the particular user with a monetary reward that is greater than the monetary fee.
